(19) United States
(12) Patent Application Publication
(10) Pub. No.: US 2019/0326045 A1
(43) Pub. Date: Oct. 24, 2019

(54) LEVITATING CROSS WITH MAGNETIC BASE AND ROTATIONAL STABILITY

(71) Applicants: William Dudley, JR., Columbia, SC (US); Kenneth L. Kramer, Sheng Shui (HK); Thomas Walker, Shenzhen (CN); Brian Thomas Wiggins, Burlington, KY (US); John B. Wilker, Dillsboro, IN (US); Anthony E. Zuiker, Malibu, CA (US)

(72) Inventors: William Dudley, JR., Columbia, SC (US); Kenneth L. Kramer, Sheng Shui (HK); Thomas Walker, Shenzhen (CN); Brian Thomas Wiggins, Burlington, KY (US); John B. Wilker, Dillsboro, IN (US); Anthony E. Zuiker, Malibu, CA (US)

(21) Appl. No.: 16/386,812

(22) Filed: Apr. 17, 2019

Related U.S. Application Data
(60) Provisional application No. 62/659,411, filed on Apr. 18, 2018.

(51) Int. Cl. H01F 7/06; G01D 5/14; H01F 7/20; H02N 15/00

(52) U.S. Cl. CPC H01F 7/064; G01D 5/145; H01F 2007/208; H02N 15/00; H01F 7/206

(57) ABSTRACT

A method and apparatus for supporting a cross in a magnetic field is provided comprising the positioning of at least one electromagnet above the cross to be levitated and connecting the electromagnet to a switchable electrical power source. The display stand preferably has a support base, a pair support members extending upwardly from the base, and an electromagnetic housing positioned between the support members and disposed over the base, spaced a distance apart from the base. A permanent magnet is disposed in an upper portion of the cross. Rotational stability magnets are positioned on distal ends of each arm of the cross, and corresponding magnets are positioned on the support members adjacent the distal ends of the cross arms, in order to provide rotational stability to the cross during levitation.

### BACKGROUND OF THE INVENTION

The ability to levitate objects in a magnetic field is considered to be useful for many applications. One obvious application is in the area of model displays and toys. Levitation is very useful for adding a sense of realism and accuracy as part of suspending many models, such as those of satellites, aircraft, spacecraft, and the like, in mid-air. It is also desirable to be able to suspend some objects that comprise an artistic formation or work in mid-air. At the same time, levitation has beneficial applications for scientific work such as the isolation of a chemical or material both electrically and physically from its surroundings. It may also be desirable to use magnetic levitation to suspend some materials during processing or storage to counterbalance some of the forces of gravity or to better control material positioning in low gravity environments.

In an attraction type magnetic levitation system, wherein a levitated member is suspended in a gravitational field free from any visible means of support, a variable magnetic field must be generated by a stationary element and the levitated member must contain a magnetic field responsive element. The stationary magnetic field can be produced by an electromagnet or a combination of a permanent magnet and an. electromagnet. A permanent magnet is defined as a magnet that retains its magnetic properties in the absence of an inducing field or current. Using a permanent magnet in addition to an electromagnet has the advantage of reducing the power consumption of the electromagnet. The magnetic field responsive element can be either a permanent magnet or a ferromagnetic material (either being capable of producing a lift force that varies with the strength of the stationary magnetic field). Using a permanent magnet rather than a ferromagnetic material has the advantage of minimizing the magnetic field strength required from the stationary field generating element and allows increased spacing between the stationary and levitated magnetic elements.

In the past, several attempts have been made to provide methods or apparatus for levitating objects. Generally, such apparatus comprises one or more electromagnets, although permanent magnets have been used in some configurations, powered by an adjustable strength current source. The electromagnets are suspended above, or below, an object to be levitated and generate magnetic fields which are used to attract metal in the object, or repel permanent magnets mounted on the object. The electrical current supplied to the electromagnets is adjusted to vary the strength of the magnetic field established by the electromagnet so as to just counter the force exerted by gravity on a suspended object.

A number of levitation systems have been described including U.S. Pat. No. 4,910,633 issued to Quinn, U.S. Pat. No. 7,110,236 issued to Joachim, U.S. Pat. No. 6,373,676 issued to Baker, and U.S. Pat. No. 6,154,353 issued to Bowers. Other levitation systems include U.S. Pat. No. 5,506,459 issued to Ritts, U.S. Pat. No. 5,883,454 issued to Hones, et al, U.S. Pat. No. 7,348,691, issued to Davis, et al, US Patent Application Publication No. US2007/01/0798 (Gohin, et al.), and US Patent Application Publication No. US2017/0063194 (Puskarich, et al.). The aforementioned patents are all incorporated herein by reference.

Quinn describes a method and apparatus for levitating objects in a magnetic field, comprising disposing at least one electromagnet having a centrally disposed core with at least one end positioned adjacent an outer surface of the electromagnet, connecting the electromagnet to a switchable electrical power source, and mounting at least one magnet on the object to be levitated.

Joachim discloses a system for holding an object in mid-air under the influence of fixed and variable magnetic forces countering the gravitational pull on the object, while Baker discloses a system that enables an object to float at a certain position unsupported by, any mechanical attachment whereby the position of the floating object is closely controlled by a microprocessor controlled electromagnetic source.

U.S. Pat. No. 6,154,353 by Bowers discloses such a system modified by the fact that the permanent magnets provide an attractive upwards force slightly greater than the downwards force on the object due to gravity. In this case the electromagnet is normally employed to provide a small repelling force to provide a fine balance and establish what might be called a dynamic balance point.

One major problem in previous levitation apparatus was to sufficiently or properly balance magnetic attraction, or repulsion, against gravitational forces on a levitated object to achieve levitation. That is, the object must be levitated with sufficient force to prevent releasing it to fall and, at the same time, without attracting it so strongly as to cause it to contact the magnet or surrounding structure. This is accomplished using a combination of sensors to detect the magnetic field strength, and feedback control over the electromagnets based on the sensor data. However, previous attempts at such controls have produced complicated, generally expensive, control circuits which operate unsatisfactorily in many applications. The sensors require very precise or critical alignment which precludes many commercial applications. Transient lateral motion or wobble of the object also causes severe problems for the feedback controls typically resulting in loss of levitation.

Another issue associated with levitation devices involves rotational stability. Some levitating devices, such as globes, are designed to rotate. However, for other types of levitating devices, it is preferred that the levitated object be generally fixed in space with no rotation. Thus, providing rotational stability is one object of the present invention. Another advantage of the present invention is that it provides for object support in a self-aligning mode that decreases sensitivity to transient lateral motion. Yet another purpose of the present invention is to provide support for objects in a magnetic field using a levitation apparatus that is both very efficient and low in complexity.

### BRIEF SUMMARY OF THE INVENTION

In view of the above problems and limitations of the art, one purpose of the present invention is to provide a method and apparatus for supporting objects in a magnetic field. More specifically, the present invention relates to a levitating cross. The levitation system disclosed herein is based on the axial attraction force between two magnetic elements, and further includes laterally disposed magnets, both within the cross itself and within the support structure, that provide rotational stability to prevent the cross from rotating.

In attraction type levitation systems, a stationary magnetic field generating element is positioned above a levitated member. The levitated member contains a magnetic field responsive element. There exists an attraction force between the stationary magnetic field and the levitated member. To assure long term axial position stability of the levitated member, the axial component of this attraction force must decrease with any increase in the height of the levitated member. To assure long term translational position stability of the levitated member, the horizontal components of this attraction force must oppose any errors in the translational position of the levitated member.

The present invention comprises a method and apparatus of levitating a cross in a magnetic field comprising the positioning of at least one electromagnet above the cross to be levitated and connecting the electromagnet to a switchable electrical power source. In one preferred embodiment, the display stand has a support base, two support members that extend upwardly from the base, and an electromagnetic housing that is positioned atop and between the support members and is disposed over the base, spaced a distance apart from the base. Preferably, a permanent magnet may be mounted an upper portion of the cross. The cross is positioned within the display such that the electromagnet suspended above the permanent magnet within the top of the cross generates a magnetic field, attracting the magnet of the cross, thus providing the proper force that allows the cross to overcome gravity and float in the display space.

The display system preferably includes electronic circuitry and elements to help achieve and maintain an equilibrium position. A magnetic field sensor, called a Hall-effect sensor, preferably provides an output signal proportional to a sensed magnetic field level. This Hall-effect sensor is able to deduce the position of the levitated object and varies its output voltage in response to changes in the magnetic field. When the sensor determines the permanent magnet of the cross to be too far away from the electromagnet of the housing, the voltage will be increased to compensate for this distance, thereby increasing the magnetic field and drawing the cross closer to the electromagnet. Conversely, if the permanent magnet of the cross moves too close to the electromagnet, the voltage will be decreased thereby decreasing the magnetic field, thus allowing gravity to lower the cross away from the electromagnet.

### BRIEF DESCRIPTION OF THE DRAWINGS

These and other features, aspects, and advantages of the present invention will become better understood with regard to the following description, appended claims, and accompanying drawings where:

FIG. 1 is a front view of one embodiment of a cross levitating within the electromagnetic display showing the outlines of magnets within the top housing of the display and the upper and arm portions of the cross in dotted lines;

FIG. 2 is a perspective cut away view of one embodiment showing the interior of the display and the cross and an electromagnet the base as well as in the upper housing and control unit the base;

FIG. 3 is a perspective cut away view of one embodiment showing the interior of the display and the cross and electromagnets in the support members along with a timer which is operatively connected the control unit in the base;

FIG. 4 is a perspective cut away view of one e di interior of the display and the cross including an electromagnet in the upper housing and upper portion of the cross;

FIG. 5 is a schematic of one embodiment of the circuitry which operates the levitating cross device;

FIG. 6 is a schematic of one embodiment of the circuitry which operates the levitating cross device; and

FIG. 7 is a schematic of one embodiment of the circuitry which operates the levitating cross device;

### DETAILED DESCRIPTION OF THE INVENTION

The present invention provides a method and apparatus for levitating or suspending a novelly cross 20 in a magnetic field. The levitation is accomplished, in a first embodiment, by securing one or more magnets 30 to one or more portions of the cross 20 to be levitated and positioning an electromagnet 31 above the cross 20. The electromagnet 31 has a fast current rise time, and decay time for the induced field in the core, and a magnetic core with a high level of saturation. A magnetic field sensor 41 is preferably mounted on a central portion of the electromagnet core and used in a feedback control loop to monitor magnetic fields between the core and magnets 30 on the levitated cross 20. A control circuit 42 is implemented as part of the feedback loop to adjust and control variations m the magnetic field generated by the electromagnet 31.

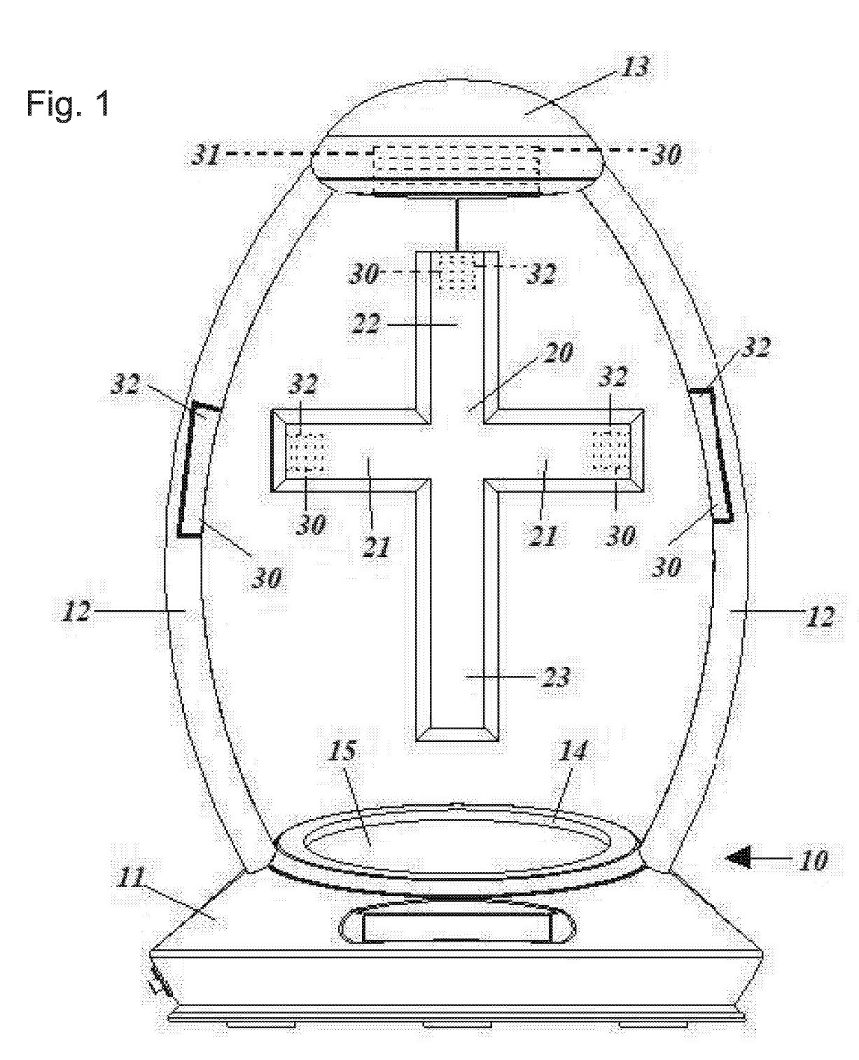

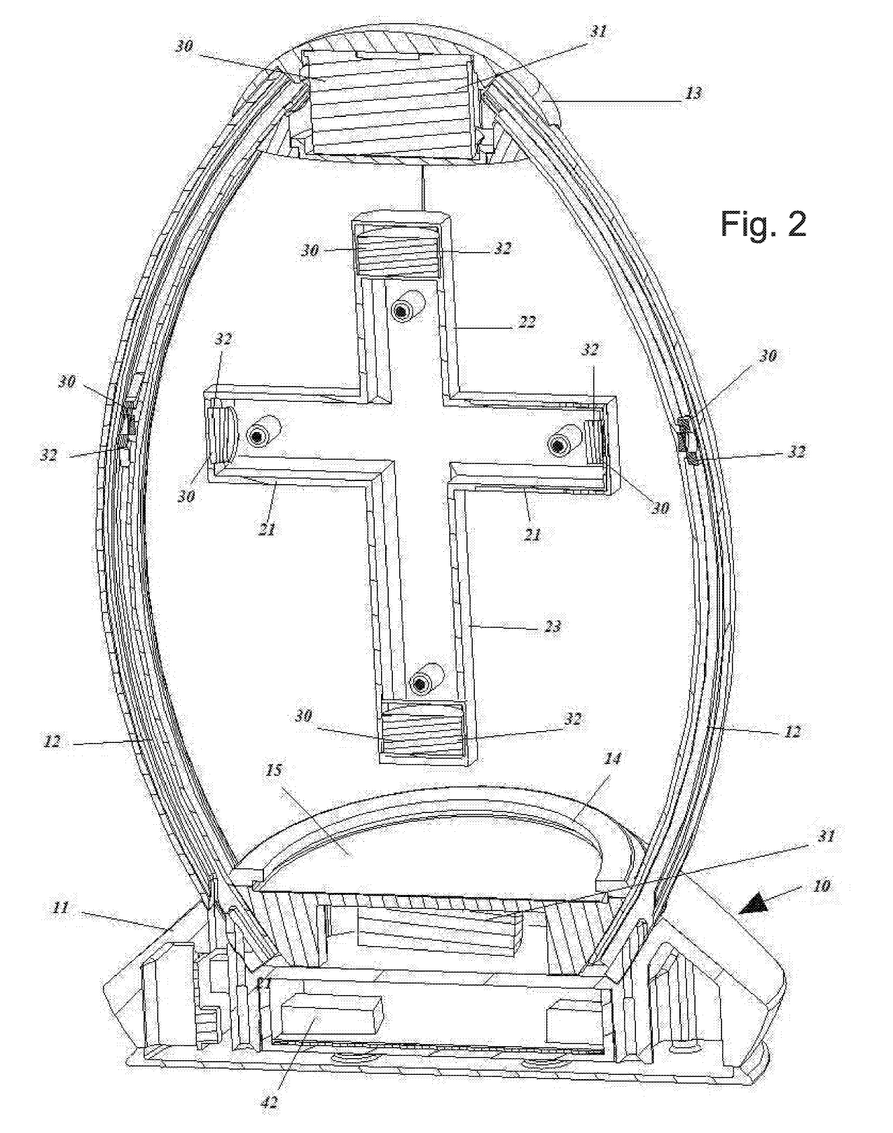

FIG. 1 illustrates a novelly cross 20 levitating within an electromagnetic display 10. The cross 20 contains at least one magnet 30, preferably a permanent magnet 32, mounted on its upper surface 22. The display 10 includes a base 11 designed to sit on a display surface with a pair of support members 12 extending upwardly from the base 11 and designed to support the electromagnet component 13 of the display 10. The housing 13 for the electromagnet 31 is positioned a sufficient distance above the lower display surface 15 of the base 11 such that a cross 20 may fit in the space between the base 11 and the electromagnet 31. When a novelty cross 20 is placed within the display 10, the upper magnet 30 of the cross 20 is positioned below the electromagnet 31, thus generating a magnetic field to attract the upper magnet 30 mounted at the top 22 of the cross 20, giving the appearance that the cross 20 is floating in the space within the display 10. Although in FIG. 1, the magnet 30 is oriented for attraction to an electromagnet 31 positioned above it, it is understood that a similar result may be obtained by locating electromagnet 31 below the object with the magnet 30 orientated for repulsion from the electromagnet 31, or that an attractive magnetic field may be used on an upper portion 22 of the cross 20 along with a repellant magnetic field at a bottom portion 23 thereof, particularly in the case of heavier crosses 20 or other levitating objects, as in FIG. 2.

In a preferred embodiment, rotational stability magnets 30 are used to prevent the cross 20 from rotating with respect to the base 11, as shown in FIGS. 1-3. For example, in one embodiment, each arm 21 of the cross 20 includes a magnet 30 at a distal end thereof, and the supports 12 include magnets 30 that are positioned to be adjacent the distal ends of the cross arms 21. This arrangement allows for rotational stability, as the magnets 30 positioned on the supports 12 are oriented to attract the adjacent magnets 30 positioned at the distal ends of the cross arms 21. In one preferred embodiment, the magnet 30 in the left arm 21 is oriented so that the “north” pole of the magnet 30 is facing outwardly, and the magnet 30 in the right arm 21 is oriented so that the “south” pole of the magnet 30 is facing outwardly. The corresponding magnets 30 in the supports 12 are oriented to attract a specific side of the cross 20, so that the left support 12 includes a magnet 30 having its “south” pole is facing inwardly, toward the “north” pole of the magnet 30 in the left cross arm 21, and similarly, the right support 12 includes a magnet 30 having its “north” pole facing inwardly toward the “south” pole of the magnet 30 in the right cross arm 21. This arrangement is shown in FIGS. 1 and 2. In this way, the front of the cross 20 is always facing forward, while the rear of the cross 20 is always facing rearward. Obviously, the polarity of each of these magnets 30 (cross arms 21 and supports 12) may be reversed, in order to achieve the same result. It should be understood that the rotational stability magnets 30 (positioned in the cross arms 21 and on the supports 12) may be positioned in a single, horizontal plane with respect to each other, or the support magnets 30 may be positioned in a slightly elevated position with respect to the arm magnets 30, in order to provide additional lifting force to levitate the cross 20.

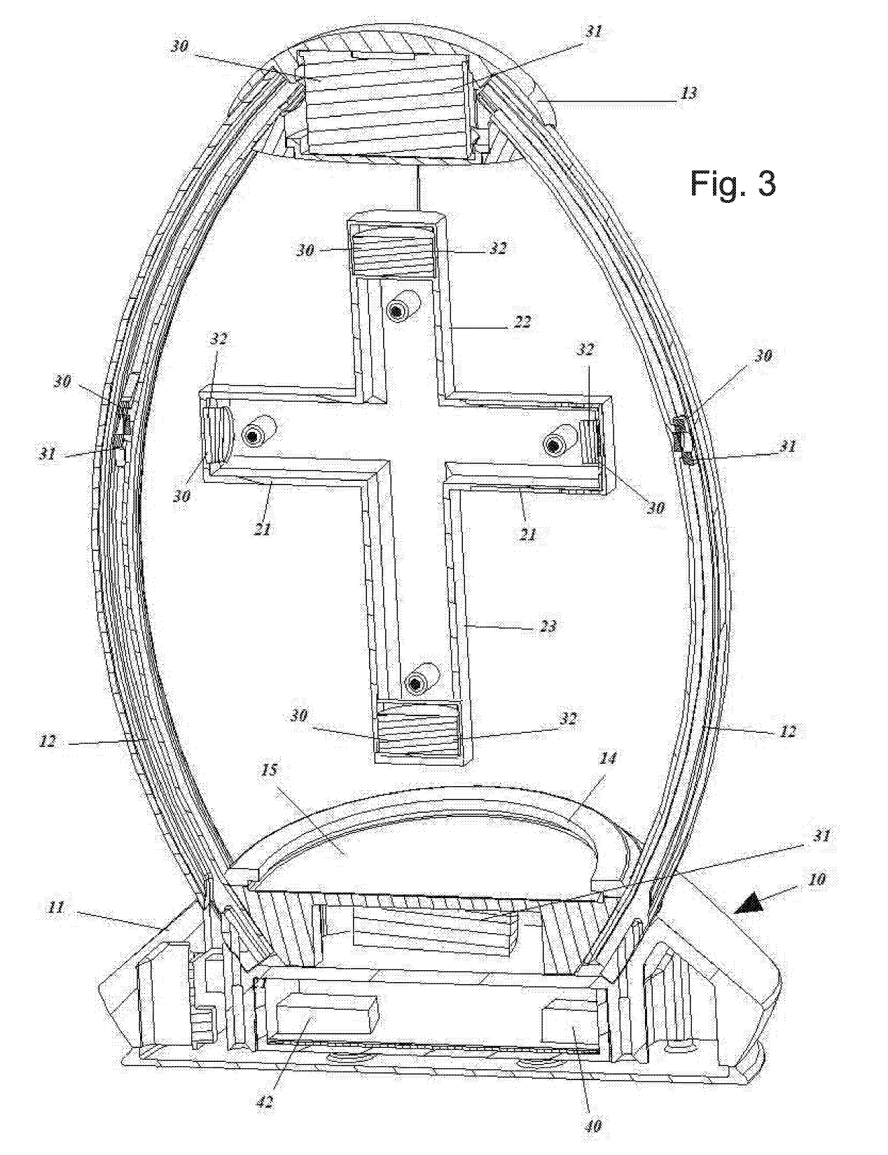

In another embodiment shown in FIG. 3, the rotational stability magnets 30 that are positioned on the support arms 21 may be electromagnets 31, and may be operationally connected to a timer 40, so that at intermittent intervals (every ten minutes or every hour, for example), the electromagnets 31 may power down and/or gradually reverse polarity, thereby causing the cross 20 to rotate one half turn, in order to display the opposite side for a period of time. This arrangement allows each side of the cross 20 to be displayed at regular intervals, if desired, and it is further contemplated that the length of time each side is displayed may be programmed by the user.

The system is designed such that any number and type of cross 20 may be used interchangeably within the same, single display 10 as desired. For example, crosses 20 having different colors or designs may be used interchangeably, as desired.

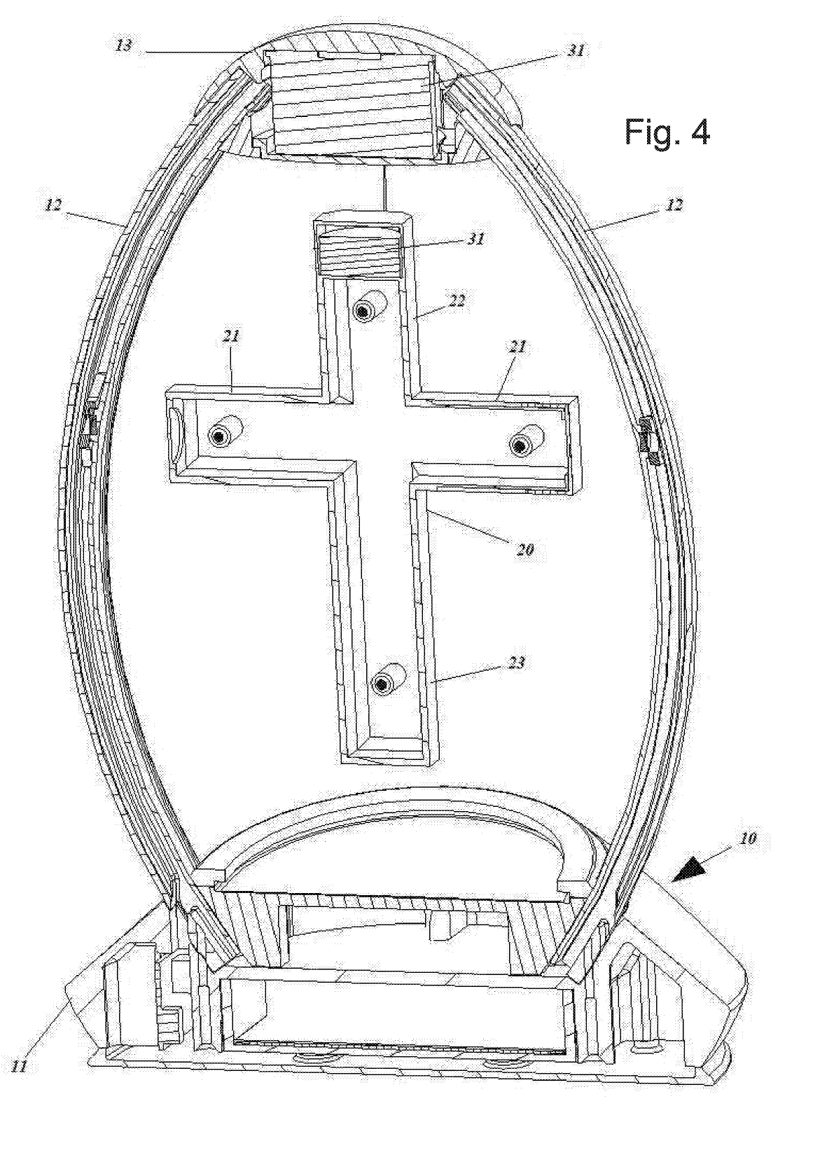

The upper magnet 30 positioned at the top 22 of the cross 20 is typically a small, preferably high strength, permanent magnet 32. Alternatively, in some applications an electromagnet 31 can also be employed at the upper cross position 22, as in FIG. 4. This arrangement allows higher field strengths, especially e superconducting materials may be available for manufacturing the conductor in the electromagnet coil. However, use of an electromagnetic structure for the magnet 30 also detracts from part of the advantage of the invention and adds complexity to the stabilization of the cross 20 since power leads (or a battery) must be accounted for.

In a preferred embodiment, the cross 20 includes a centrally located receptacle on an upper portion thereof, which is adapted to hold at least one magnet 30. This receptacle is preferably square-shaped but may be any shape or size corresponding to the magnet(s) 30 that are to be inserted. It is contemplated that magnets 30 of different strengths may be needed to levitate crosses 20 of differing weights; therefore, the receptacle preferably includes at least one snap-fit flange to allow for the easy removal and insertion of interchangeable permanent magnets 32. The magnet receptacle is designed to fit in the upper portion 22 of the cross 20.

The structure shown in FIGS. 1-4 is, for purposes of illustration and clarity, used only in describing the invention and can have many alternative shapes or designs. As for example, the display 1.0 can employ a visual representation which matches or corresponds to the aesthetic appearance of the cross 20 to be levitated. The support base 11 is preferably flat and may be generally round, square, or any other desired shape. Similarly, the electromagnetic housing 13 supported on either side by the support members 12 may be any desired shape capable of enclosing the electromagnetic components.

The housing 13, base 11, and support members 12 of the display 10 are preferably constructed from ABS plastic but may also be constructed from any other type of plastic, rubber, or other suitable material. The base portion 11 may include a lipped edge 14, whereby interchangeable decorative display discs may be placed within the lipped portion 14 of the display. In this embodiment, it is contemplated that decorative discs representing pictures of loved ones, pets, and the like may be represented and interchanged as desired. Additionally, the upper housing 13 for the electromagnet 31 may also include an area whereby a similar commemorative or interchangeable wrap may be displayed or wrapped around the housing 13.

The housing 13 houses an electromagnet 31 that employs a series of windings disposed on a centrally positioned core comprising a substantially solid ferromagnetic material having a high magnetic field saturation value and a rapid rise time and decay in the induced field, preferably an energizable copper-wound coil contained within a steel tube and surrounding a steel core. The electromagnet 31 generally comprises a cylindrical coil wrapped tightly about a cylindrical core, although the core can also have elliptical, triangular, rectangular or other geometric shapes for its cross-section and still be useful for the present invention. The core is generally positioned at the center of a central longitudinal axis extending though the electromagnetic coil. However, the core need not occupy an exact centerline position within the coil.

In order to set up and use the device, a user simply turns on the electromagnet 31 by pressing a button on the base 11, and then holds the cross 20 beneath the electromagnet 31 at a predetermined distance (adjusting the position as necessary)until the cross 20 begins to levitate, and then simply releases the cross 20. In one embodiment, a spacer member may be used to indicate and set the predetermined distance between the top of the cross 22 and the bottom of the electro-magnet 31. To use the spacer member, a user places the spacer member, in a proper orientation, against the bottom of the electromagnet 31, and the spacer member is dimensioned so that it provides the specific distance required between the electromagnet 31 and the top of the cross 22. Then, while holding the spacer unit below and against the bottom of the electromagnet 31, the user places the cross 20 below the spacer, so that the top of the cross 22 is touching the bottom of the spacer member. Then, the user slowly removes the spacer member, and the cross 20 should be at the proper and correct distance below the electromagnet 31 to allow the cross to begin levitating, and the user may then release the cross 20 for the levitation operation. In a preferred embodiment, the spacer member is in the shape of the cross 20, and the width (front to back) of the spacer member should correlate directly to the optimal distance between the levitating cross 20 and the electromagnet 31, so that the spacer should be oriented in a horizontal plane (as a cross sitting flat on the ground would be) between the top of the cross 22 and the bottom of the electromagnet 31. It is contemplated that the base 11 may include a compartment and a door or hatch that may house and store the spacer member when not in use. This arrangement allows a user to have access to the spacer unit at all times, and may be used to prevent the levitating cross 20 from coming into hard contact with the electromagnet 31 while attempting to levitate the cross 20.

The electromagnet 31 is constructed according to principles and techniques well known in the art and a variety of such magnets are available that are useful with the method and apparatus of the present invention. In an exemplary embodiment, the electromagnet coil was constructed from number gauge copper wire wrapped in about 570 turns about a ferrite core. However, other material such as nickel alloys can be used to construct the core. It is only necessary that the core be highly attractive of other magnets 30.

The electromagnet 31 is held in place using one of a variety of fastening techniques such as, but not limited to bolts, C or U-shaped clamps, adhesive, or bonding agents (epoxy or casting resins). Where the magnetic fields employed allow a sufficiently large separation distance between the levitated cross 20 and the electromagnet 31, the electromagnet 31 can be supported on a non-magnetic material such as a sheet of plastic or metal which can extend between the cross 20 and the core. This arrangement has the advantage of better allowing incorporation of the electromagnet 31 into a shell or other form of housing 13 that is part of a display device 10 without leaving the electromagnet 31 visible.

The magnetic field strength required for the magnet 30 is determined by the mass of the cross 20 to be supported in the generated magnetic fields. Obviously, larger crosses 20 require larger magnetic field strengths. The field strength for attracting the magnet 30 to the core at the point of levitation is estimated to occur for a field force equivalent to at least 60-80 percent of the weight of the cross 20. The remainder of the necessary attraction comes from the electromagnet 31 and is typically supplied in short pulses.

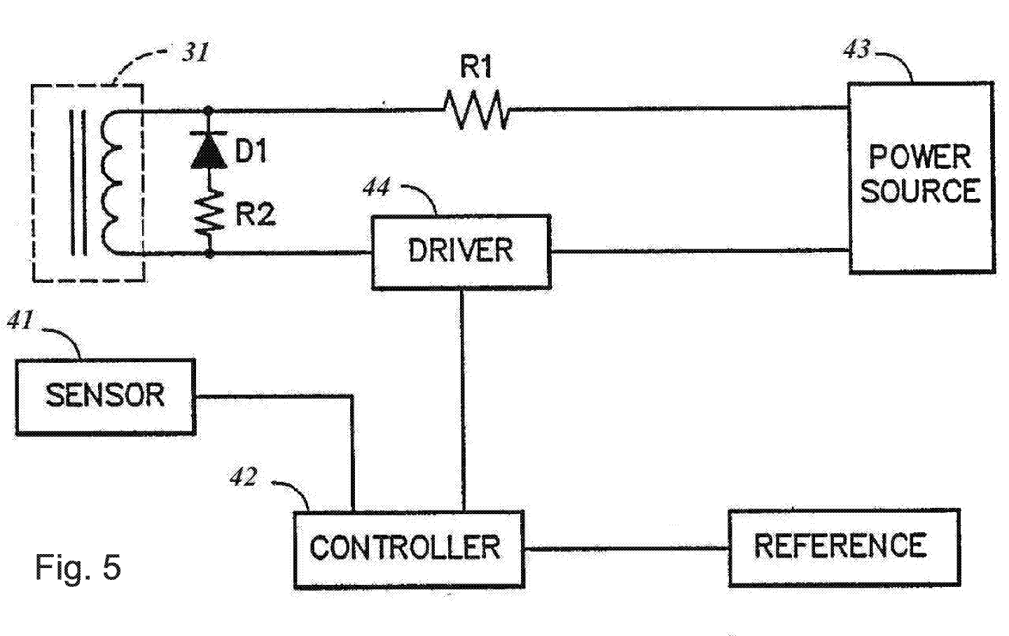

As seen in FIG. 5, the electromagnet 31 is connected through wires or cables to a current driver 44 and power source 43. In a preferred embodiment, the power source 43 is a low voltage, pulse modulated DC (direct current) source, which may be provided by a battery, an inverter, or any other suitable low voltage DC power source. The electromagnet 31 generates a magnetic field according to various levels of current or power provided by the power source through the driver 44. The settings are chosen with regards to stable positioning of the cross 20. The driver 44 switches or pulses the electromagnet 31 to achieve a fine tuning of the magnetic fields extending between the electromagnet core and the magnet 30 to provide a stable, and self-aligning operation for the levitation apparatus. The driver 44 is actuated by a controller 42 which uses information or an output signal provided by the magnetic field sensor 41 to determine the relative field strength to be provided by the electromagnet 31.

As stated previously, the structure of the present invention functions attraction of the magnet 30 to the material comprising the core of the electromagnet 31 to provide the main upward force for levitating the cross insert 20. In the alternative, the invention can operate by repulsion against a magnet 30. It is estimated that on the order of 75 to 90 percent of the force required for levitating the cross 20 should be provided by the magnet(s) 30 interacting with the core.

The core has at least one end positioned adjacent an outer surface of the electromagnet 31. At least one magnetic field sensor 41 is disposed adjacent this core end, preferably separated from the core end by a steel plate and is configured to provide an output signal indicating a relative magnetic field strength. As in FIG. 5, a field strength controller 42 is connected to the sensor 41 and in series with the power source 43 for adjusting electrical power delivered to the electromagnet 31 in response to variations in cross position from a desired position.

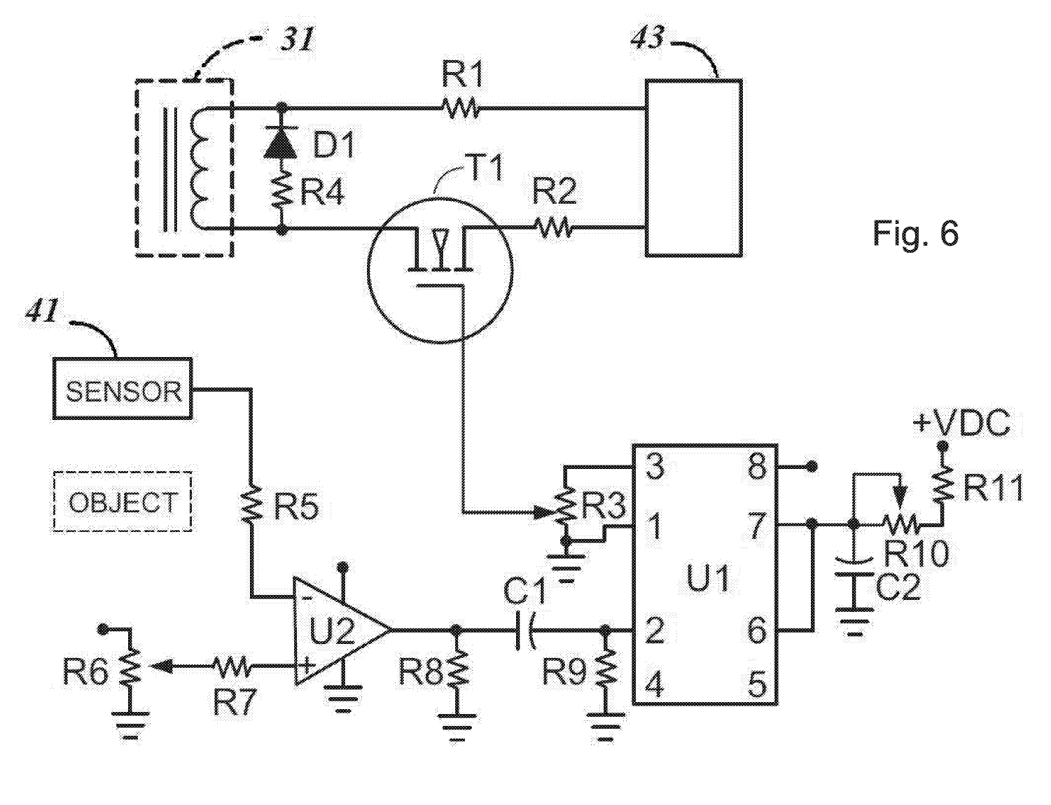

Referring to FIGS. 5 and 6, the magnetic field sensor 41 preferably provides an output signal proportional to a sensed magnetic field level. The magnetic field controller 42 comprises a reference voltage generator for generating a selected, but adjustable, reference voltage level signal which is monitored by a voltage comparator U2 connected to both the sensor 41 and the reference generator for comparing respective voltages generated by each and for providing an output signal indicative of a relative status of the two. The output from the comparator U2 is used to control or gate power to the electromagnet 31.

In one embodiment, the field strength of the object magnet 30 relative to the fixed end of core position is determined by Hall-Effect sensor, as the magnetic field sensor 41. A Hall-effect sensor is a transducer on the end of the core with a fixed orientation with respect to generated magnetic fields and detecting voltages produced by said transducer. The sensor is preferably fixed at a location at the bottom of, but spaced apart from, the electromagnet 31 so as to be positioned between a permanent magnet 32 of the cross 20 and the electromagnet 31 of the housing 13. This Hall-effect sensor is able to deduce the position of the levitated cross 20 by the magnetic field of the magnet 30 on the insert and varies its output voltage in response to changes in the magnetic field. Thus, once the equilibrium position of the cross 20 is established, a change from that equilibrium will produce either an increase or decrease in the magnetic field passing through the sensor, which, in turn, produce a change in the voltage monitored by the sensor. In the event that the permanent magnet 32 of the cross 20 moves too far away from the electromagnet 31 of the housing 13, the magnetic field will decrease. Conversely, if the permanent magnet 32 of the cross 20 moves closer to the electromagnet 31, the magnetic field will increase. When the comparator U2 connected to the sensor determines these changes in the magnetic field, an increase or decrease in the voltage applied to the coil of the electromagnet 31 will compensate. For example, an increase in voltage applied to the coil of the electromagnet 31 will increase the electromagnetic field, thus increasing the magnetic attraction and drawing the cross 20 closer to the electromagnet 31. Conversely, a decrease in voltage applied to the coil of the electromagnet 31 will decrease the electromagnetic field, thus decreasing magnetic attraction and permitting gravity to lower the cross 20 away from the electromagnet 31.

During operation, the current driver 44, or switcher, interrupts and controls the flow of current to the electromagnet 31 from the power source 43. The current driver 44 is connected between the power source 43 and the electromagnet 31 and has a control input which is connected to a comparison/timer element U1 in the controller. The comparison element U2 is connected at a first input to the magnetic field sensor 41 to receive an output voltage or signal from the sensor 41. A second input of the comparison element U2 is connected to the reference voltage source R6/R7. The reference voltage source R6/R7 has an output which is adjusted to match the output voltage of the sensor 41 when the cross 20 is suspended in a desired position or at a desired levitation height. It will be readily understood by those skilled in the art that the output of the reference voltage source should be adjustable and is adjusted according to the weight or mass of the cross 20 and the type and number of magnets 30 employed. However, once adjusted for a particular levitation position, the voltage source should not require further adjustment during use unless the weight of the cross 20 is changed.

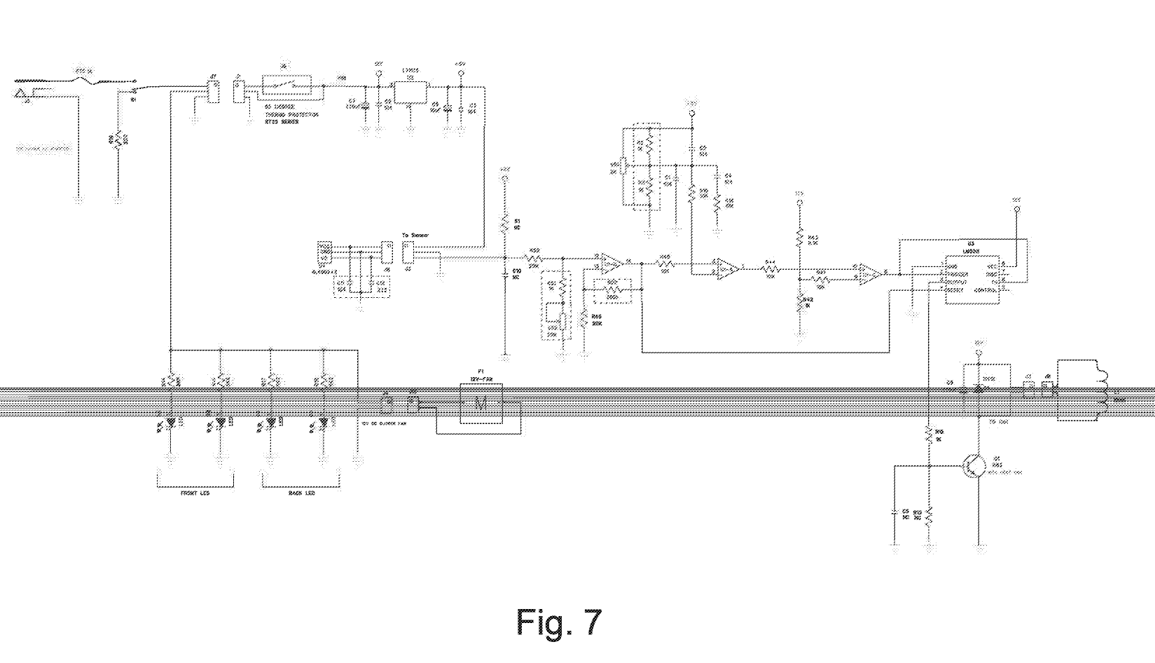

The circuitry of the present device is better understood by reference to FIG. 7 showing one embodiment thereof. In section “A” of the schematic, the voltage measured by the sensor 41 is directed to the remainder of the circuit. In section “B”, the voltage measured by the Hall-effect sensor 41 is amplified by an Operational Amplifier (Op Amp) U1-D to a level wherein it can be processed by the remainder of the circuit.

The voltage output of the Operational Amplifier U1-D in section “B” is sent to an Operational Amplifier U1-A used as a comparator in Section “C”. The voltage measured by the sensor 41 goes to one input of the comparator while a reference voltage signal that is indicative of sensor voltage reading for the cross 20 in equilibrium goes to the other comparator input. The reference voltage is set through the use of a variable resistor VR.

The output of the comparator Operational Amplifier U1-A ultimately triggers a timer integrated circuit U3 in section “E” of the circuit. The output of the timer U1 causes a pulsed voltage of 12 volts to be applied to the coil of the electromagnet 31 through a voltage regulator circuit (see section “E” of circuit diagram).

The magnet of the insert, the coil and other circuit components are selected by a combination of mathematical computations and experimentation to create a system in which the cross will attain an equilibrium floating position.

A voltage divider circuit that includes an integrated circuit provides 12 volts to parts of the circuit (timer, voltage regulator, and coil) and 5 volts to other parts of the circuit (sensor, reference voltage).

The apparatus is used by first energizing the circuit and establishing the equilibrium position of the magnet 30 of the cross 20 insert through experimentation and/or mathematical computation. The variable resistor VR associated with circuit section “C” is used for this purpose. Once the setting of the VR is established, the circuitry then operates to maintain the position of the cross 20.

Referring back to FIG. 6, an embodiment of circuitry used to implement the driver, controller, and reference source are illustrated in further detail in schematic form. The Hall-effect sensor is shown positioned between the electromagnet 31 and the magnet 30 of the cross insert 20. The coil of the electromagnet 31 may be connected on one end to a power source through a current control or limiting resistor R1. A typical value for resister R1 is 5 ohms. The power source provides the necessary voltage and current for operating the coil and represents one of a variety of power supplies known in the art. The other end of the coil is connected to a power FET type transistor T1 which switches on and off to gate current through the coil to ground. In a preferred embodiment, the FET T1 is used as a switchable ground, however, it can also be connected to a lower or higher voltage level terminal of the power source as desired, taking into account the proper polarity of the transistor. The FET T1 may be connected through an isolation and current limiting resistor R2 to a ground terminal of the power source. The resister R2 is typically on the order of 0.25 ohms in value.

The FET transistor can comprise one of several known relatively high power or high current FET transistors commercially available. An exemplary transistor for T1 is an N-channel power FET supplied by the Siemens Semiconductor and designated by part number BUZ20. However, those skilled in the art will understand how to select other FET and non-FET type transistors to accommodate the switching function of T1 where applicable.

The control or input gate of the transistor T1 is connected to an output terminal for the timing circuit U1, discussed below. The output terminal is connected to the transistor T1 through a variable resister R3 to control the voltage range applied to the gate of the transistor T1.

A diode, D1, in series with a resister R4, is connected in parallel with the coil to provide a discharge path for the coil to prevent damage to circuitry when transistor T1 cuts off.

The magnetic field sensor 41 preferably comprises a Linear Output Hall Effect Transducer produced by the Micro Switch company division of Honeywell Corporation and generally referred to by the trademark LOHET. This type of sensor is chosen for its is highly linear, stable, and field orientation sensitive output. In addition, this type of sensor is packaged in a configuration that makes installation very simple and compact. However, other types of field sensors can be integrated into the circuitry of the present invention.

The main control circuit, which corresponds to the controller, comprises a voltage comparator U2 connected to receive input voltages from the transducer and a variable level voltage reference on an input side and to a timer, U1, on an output side. The comparator U2 is connected to the transducer through a resister R5 and to a variable resister R6 through a resister R7 which is used to establish a desired reference voltage. An exemplary circuit element found useful for the voltage comparator, U2 is an operational amplifier circuit manufactured by the Texas Instruments company under the part designation TOP271CP. However, those skilled, in the art will readily recognize that other circuit elements are useful to implement the comparator U2.

The output of the comparator U2 is connected to a trigger input of a timing device U1. Typically a resister and capacitor network is used to shape the output from the comparator U2 to provide an appropriate trigger signal for the timer U1. These components are shown as resisters R8 and R9 and capacitor C1. This provides a low going trigger pulse of controlled voltage level instead of a steady state output level as would normally be present on the output terminal of the comparator U2.

The timing device which can comprise a linear monolithic IC 555 timer, has appropriate timing control components such as resistor R10 and capacitor C2 connected to terminals for setting basic timing. A variable resister R10 is found very useful in setting the pulse duration output to the transistor T1. This control is especially valuable if there is no resilient supports or connections used for the magnet 30. This control fine tunes the position setting pot and acts somewhat like a gain control in a feedback circuit. In addition, a resister R11 may be used to set the shortest minimum pulse length for the pulse applied to the gate of the transistor T1.

The output of the timer U1 is used as a pulse source for the FET T1 which is applied to a gate to turn on the FET T1. The start of the gate pulse is determined by the comparator inputs changing relative potentials, i.e., B greater than A, to A greater than B. The output of the comparator in this design will cause the timer to start a gate pulse when it changes from a high state to a low state. The gate pulse duration will be controlled by the timer's external circuitry. This gate control circuitry can be made in many ways by those skilled in the art.

As discussed above, the transducer is mounted on or adjacent to the end of the core that faces the cross. The active portion of the transducer is positioned substantially in the center of the core and detects the field of the magnet as it interacts with the core.

The transducer's output is connected to the inverting input of the comparator U2, a reference voltage is selected off the voltage divider provided by R7 and applied to the noninverting input. The transducer's output with no magnetic field present is approximately one half the supplied voltage. Depending on the direction of the magnetic field, the output will be driven either higher or lower than this midpoint.

In this design, as the magnet 30 gets closer to the electromagnet core the output of the transducer decreases toward zero volts. When the output of the transducer is lower than the reference voltage, the comparator U2 outputs a high-level voltage which indicates that the cross 20 is too close to the electromagnet 31. If the output of the transducer is higher than the reference voltage, the output of the comparator U2 is low or zero which indicates the cross 20 is drifting too far away from the electromagnet core.

The pulse shaping network transfers a low going pulse to the trigger of the timer U1 when the output of the voltage comparator U2 goes low, a high going signal has no effect on the trigger circuitry. If the timer U1 receives a low going pulse on the trigger input it begins a timing cycle. While in a timing cycle or mode, the timer U1 provides or generates a high level output signal which is applied to the gate of the power transistor T1. The transistor T1 is turned on by the presence of this signal and remains on as long as the output from the timer U1 is high. Therefore, the pulse width of the FET transistor T1 output is determined by the timing or duty cycle of the timer circuit, with the start of the pulse being determined by the comparator.

While the FET transistor T1 is turned on, the output from the transducer decreases. This results from current applied to the electromagnet 31 which generates a magnetic field oriented in the same direction (pole to pole) as the permanent magnet 32 on the cross 20. This causes the output of the comparator U2 to go positive which prevents constant triggering of the timer U1 as current flows to the electromagnet 31.

The transducer is also normally blind to the presence of the magnet 30 during the time the electromagnet 31 is on and will not be able to sense the cross's presence until the magnetic fields in the ferrite core for the electromagnet 31 die down or decay to a sufficiently low value. As soon as the output level from the transducer increases above the reference voltage input to the comparator U2, in other words the cross magnet 30 is too far away, the comparator U2 output goes low turning on the timer U1 and the electromagnet 31 and pulling the magnet 30 closer.

Although the present invention has been described in considerable detail with reference to certain preferred versions thereof, other versions are possible. For example, although the present invention has been described as levitating an object in the shape of a cross, it is understood that the levitating object may take other shapes and forms, as well, without departing from the spirit and scope of the present invention. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. An apparatus for levitating a cross in a magnetic field comprising:
a display stand comprising a support base, two support members extending upwardly from the base, and a top member connected to an end of said support members opposite said support base so said top member is disposed a fixed distance away from said support base;
a first electromagnet housed within said top member to generate a magnetic field;
at least two magnetic elements, one housed in each of said support members at a to location between said end connected to said top member and the end contacting said support base; and
a cross to be levitated comprising a first magnetic element disposed in an upper portion of said cross so said magnetic field generated by said first magnetic element within said cross attracts said first electromagnet and permanent magnets housed within each of the lateral arm distal ends of said cross so each can be attracted by one of said magnetic elements housed in said support members.

2. The apparatus of claim 1, wherein said first magnetic element comprises an electromagnet.

3. The apparatus of claim 1, wherein said cross includes a user-accessible receptacle to house and secure said first magnetic element and which allows for removal and replacement of said first magnetic element.

4. The apparatus of claim 1, further including a second magnetic element within a lower portion of said cross and a second electromagnet housed in said support base below said lower portion so the magnetic field generated by said second magnetic element repels said second electromagnet.

5. The apparatus of claim 4, wherein said second magnetic element comprises an electromagnet.

6. The apparatus of claim 1, wherein variation of power supplied to said first electromagnet alters the distance between said top member and said upper portion of said cross.

7. The apparatus of claim 6, further including a feedback control-circuit and at least one magnetic field sensor, wherein the amount of power supplied to said first electromagnet is determined by electrical output from said magnetic field sensor.

8. The apparatus of claim 7, wherein said magnetic field sensor is disposed on a central portion of the core of said first electromagnet.

9. The apparatus of claim 7, wherein said magnetic field sensor comprises a Hall effect sensor.

10. The apparatus of claim 1, wherein said magnetic elements housed in said support members comprises an electromagnet.

11. The apparatus of claim 10, wherein said support member magnetic elements can reverse polarity to facilitate rotation of said cross around a vertical axis through said support base, upper and lower portions of said cross, and said top member.

12. The apparatus of claim 11, further including a timer that is operationally connected to said support member magnetic elements to control the frequency of polarity changes of said support member magnetic elements.

13. An apparatus for levitating a cross in a magnetic field comprising:
a display stand comprising a support base, two support members extending upwardly from the base, and a top member connected to an end of said support members opposite said support base so said top member is disposed a fixed distance away from said support base;
a first electromagnet housed within said support base to generate a magnetic field;
at least two magnetic elements, one housed in each of said support members at a location between said end connected to said top member and the end contacting said support base; and
a cross to be levitated comprising a first magnetic element disposed in a lower portion of said cross so said magnetic field generated by said first magnetic element within said cross repels said first electromagnet and a permanent magnet housed within each of the lateral arm distal ends of said cross so each can be attracted by one of said magnetic elements housed in said support members.

14. The apparatus of claim 13, further including a feedback control circuit and at least one magnetic field sensor, wherein the amount of power supplied to said first electromagnet is determined by electrical output from said magnetic field sensor.

15. The apparatus of claim 13, wherein each of said magnetic elements housed in said support members comprises an electromagnet.

16. The apparatus of claim 15, wherein said support member magnetic elements can reverse polarity to facilitate rotation of said cross around a vertical axis through said support base, upper and lower portions of said cross, and said top member.

17. The apparatus of claim 16, further including a timer that is operationally connected to said support member magnetic elements to control the frequency of polarity changes of said support member magnetic elements.
